(19) United States
(12) Patent Application Publication
(10) Pub. No.: US 2005/0217927 A1
(43) Pub. Date: Oct. 6, 2005

(54) Single and multiple reflection wave guide

(76) Inventors: Guido Noselli, Flero (IT); Stefano Noselli, Flero (IT); Michele Noselli, Flero (IT)

Correspondence Address: MCGLEW & TUTTLE, PC, P.O. BOX 9227, SCARBOROUGH STATION, SCARBOROUGH, NY, 10510-9227, US

(21) Appl. No.: 10/517,694

(22) PCT Filed: Mar. 4, 2003
(86) PCT No.: PCT/IT03/00123

§ 371 Date: Dec. 8, 2004

(30) Foreign Application Priority Data
Jul. 9, 2002 (IT) BS2002A000063

(51) Int. Cl. G10K 11/00

(52) U.S. Cl. 181/191; 181/176

(57) ABSTRACT

The invention regards a method of sound diffusion by means of a horn or reflection wave guide, which includes the transformation of at least a sound emission source into a virtual point source exactly equal to a “real” point source, and diffusion of the sound from the “real” point source, with sound reflection by means of at least one reflecting surface, maintaining equal sound paths from any point of the emission source. The invention also regards a reflecting wave guide with a sound reflection surface positioned in front of the sound emission plane and configured to transform this sound emission plane into a real point source, and at least one reflection surface combined with the real point source for diffusing the sound towards a measurement or listening position.

### FIELD OF THE INVENTION

This invention concerns the loudspeaker enclosure sector in general, and refers particularly to a wave guide system fore sound reproduction and diffusion.

### Prior Art

In the professional sound reproduction field, there has been increase in the design and manufacture of new loudspeakers systems built for professional use, in which all the possible techniques have been applied for efficient control of the directivity for wide sound frequency bands.

While for home use the need to control this parameter is not yet felt to this extent, in the professional sound amplification in general, sound reinforcement, concerts, audio amplification in environments which are often acoustically poor, such as indoor sports arenas, places of worship, etc., directivity control over the entire audio spectrum to be reproduced has on the other hand become “the last frontier” to overcome for substantial improvement of sound system performance.

Directing sound to the areas where the audience is located and only to area, without a great deal of sound being dispersed in other unwanted directions, is without doubt a great advantage from the point of view of both quality and quantity. In fact, on one hand, with efficient control of directivity and therefore of the loudspeaker system's sound dispersion, there's no alteration in the reproduction of the original signal directed from the enclosures to public, needlessly exciting the environment in which the event is taking place, giving rise to interference and harmful vibration due to reflection on the walls and surfaces around this environment, and on the other hand restrict the sound emitted by the loudspeaker system to the required direction and to an determinate coverage angle, leads to the elimination of a large waste of sound energy, practically speaking all the sound not fed in the required direction, with consequently improved exploitation of the performance the system is able to provide.

In fact, the smaller the area to be covered or at least the smaller the angle in which the sound wave is fed, the less electric power will be required to drive the system, at the same acoustic level in the area involved. In other works, for this precise feature, an extremely directive system will have a high Q, or directivity factor, with an increase in the DI (directivity index), which results from this and therefore, in the end an increase of the acoustic gain.

To meet this requirement, a type of enclosure (or to be more exact an enclosure configuration) is once again extremely topical: speaker columns—vertical line arrays, which had already been widely used successfully in the past, at the outset of professional sound reinforcement, with the aim of considerably controlling vertical directivity in order to obtain a cylindrical rather than spherical wavefront and which had later been almost abandoned, because it was costly and complicated to obtain good wide-range performance able to meet the quality requirements which through the years had increased in all sectors of professional audio compared with poor initial needs. One example of this situation is to be seen in FIGS. 1A, 1B and 1C, illustrating respectively a vertical sound line, a spherical wavefront diagram, and a diagram of a cylindrical wavefront.

Modern digital electronics and in particular the use of DSP (Digital Signal Processing) contributed a great deal to this comeback, because DSP units enabled to overcome many of the limits which line array systems imply regarding quality requirements, by means of the application of techniques which have already been well known for years, but difficult and expensive to put to practical use, such as the so-called “steered array” techniques, described by Olson in the fifties, which use the time and phase alignment of each individual unit making up the array. With DSP units, it's relatively easy nowadays to align the emission of individual sources positioned one above another in arrays to eliminate destructive interference caused by the differences in the sound's path the listening point or to obtain virtually any directivity pattern, by applying controlled sound delay or phase shift to the separately powered individual loudspeakers or enclosures.

In spite of the enormous possibilities offered by DSP, some insurmountable limits still remain however in these systems which make them in any case difficult to construct, particularly if they're intended for high quality professional use; moreover in them, an it's no trivial matter, this last characteristic (quality), cannot be separated from a great capacity to generate sound pressure.

The aforementioned limits are of a physical nature and closely linked with the dimensions of the individual sources, loudspeakers or systems involved. Overcoming them or rather not taking them into consideration when designing any vertical array of loudspeaker enclosures, inevitably leads to a sound system with destructive interference, which jeopardizes its quality and basic performance.

In recent years, many people have worked on the operation of vertical line arrays and all have agreed and proven that a vertical line array, operating correctly from the point of view of angular emission, therefore able to emit a cylindrical wavefront as opposed to the traditional spherical wavefront (FIG. 1B, 1C), and operating well from the point of view of quality, must respond to two fundamental requisites as well as the standard ones.
a) The surface occupied by the active sources must be no less than 80% of the total surface of the array.
b) The sources must therefore be closely coupled and have a distance between them of no more than half a wavelength, referred to the highest frequency they have to reproduce.

These two requisites applied mean that a certain number of sources (point sources compared to the frequencies they must reproduce) generate a planar sound wave on the coupling plane similar to that which would be generated by an effectively flat sound source with the same dimensions, the starting point for obtaining a cylindrical wavefront.

If it's easy to achieve these for low frequencies, it's a little less so for mid frequencies where, in fact, the respect of the requisites at 1000 Hz (½ wavelength=approximately 17 cm.) already implies the use of sources that don't exceed the dimension of 17 cm. (a 6.5″ loudspeaker) with all the consequent results in terms of poor efficiency. Then, for frequencies above 1000 Hz, the dimensions of the sources must gradually drop to values that are only theoretical and physically unfeasible for real sources such as loudspeakers. These aspects of the technique are schematized in FIGS. 2A, 2B, 2C and 2D, respectively showing a dimensional example (measurements in mm.) of a vertical speaker column, and the propagation of the sound at a frequency of 1000 Hz, 2000 Hz and over 2000 Hz, taking into consideration the dimension of the vertical speaker column shown.

Therefore, for example to reproduce frequencies up to 10,000 Hz (½ wavelength=1.7 cm), one should closely couple sources that don't physically exceed this dimension. Even supposing such small loudspeakers (magnetic circuitry included) can be built, it's easy to imagine that it would be a waste of time, due to the practically non-existent efficiency of loudspeakers of that type.

Creating vertical line arrays that operate well at high frequencies therefore becomes a practically insurmountable physical question if one wants to use traditional loudspeakers such as for example cone or dome units. But horns of any kind, which by their very nature are flared conduits with a mouth surface area with dimensions which are not negligible and suited to the lowest frequency that must pass through them, don't allow to form line arrays operating correctly according to the listed requisites. FIGS. 3° and 3B respectively show an dimensional example (measurements are in mm) of a speaker column and the schematic illustration of the propagation of the sound in the conditions occurring with the speaker column in FIG. 3A to emphasize how at high frequencies there is interference in the horns' emission due to the distance between them.

At present, with regards to frequencies of over 1000 Hz, the most suitable type of loudspeakers for obtaining efficient line arrays are those with the various types of flat diaphragm, electrostatic, ribbon, isodynamic, etc.

FIGS. 4A, 4B and 4C show an example of vertical coupling of several loudspeakers (FIG. 4A) without destruction of the sound emission by interference, a flat diaphragm loudspeaker (FIG. 4B) and a diagram of its cylindrical wavefront (FIG. 4C).

However, these flat diaphragm loudspeakers, for an inherent matter of construction, are generally speaking not particularly efficient and anyway only a few very expensive models, with powerful Neodymium magnetic circuits, achieve SPL (Sound Pressure Level) of a certain level. These levels are in any case still far from those reached by the most widespread components in the pro audio field for high frequency reproduction: compression drivers.

This is why many manufacturers have undertaken the construction of particular wave guides or special acoustic adaptors that enable to use the very widespread compression drivers in multiples to reproduce high frequencies in line array systems. FIGS. 5A, 5B and 5C give a general illustration of the use of compression drivers in horns or wave guides coupled in vertical speaker columns to minimize destructive interference. FIG. 5A is a more detailed design of a typical compression driver with a circular throat; FIG. 5B shows the diagram of use of several drivers coupled together after the transformation of their circular throat into a vertical slot to form a speaker column; FIG. 5C shows the diagram of the imperfect propagation of the sound with the series of drivers in FIG. 5B.

Considering the fact that the elements most suited to forming vertical line arrays are those with flat diaphragms, as they emit planar sound waves for frequency bands with wavelengths which are smaller than the dimensions of the diaphragm; having seen that the diaphragm of these units, when they're positioned one above another form a continuous vertical “ribbon”, able to move in a planar way and in phase, as if it was the diaphragm of one very high narrow loudspeaker, creating a cylindrical wavefront which controls the vertical directivity for a very wide frequency band starting from relatively low ones, whose wavelength is comparable or smaller than that corresponding numerically to the height of the vertical line array formed by all these diaphragms one above each other; and considering this a very favourable characteristic for constructing line vertical arrays able to create a cylindrical wavefront at high frequencies too, all researchers' work aimed at obtaining the same behaviour from a compression driver.

In other words, they tried to find (and some effectively found) how to transform the planer emission of the circular surface of a compression driver's throat into an equally planar emission, such as that obtained with a ribbon-shaped (rectangular) diaphragm, in order to get as close as possible to the behaviour typical of flat loudspeakers with a flat diaphragm.

The simplest and most intuitive way, on behalf of a lot of them, was to construct horns or wave guides, connected together in such as way as to form, when placed one on top of another, an emission slot, which in turn became the throat of a horn with parallel vertical walls and side walls inclined in such a way as to achieve the required horizontal dispersion, as is shown in FIGS. 5A, 5B and 5C.

However this system, although optimised with many different devices by various manufacturers, doesn't enable to equal the results of the flat diaphragm which, as will be remembered, seems to be the only geometrically correct one for building high frequency line arrays.

The techniques shown (or similar ones) simply enable to reduce the effect of the interaction occurring between the elements, taking them to the highest possible frequencies compatible with their physical dimensions. An innovative and definitely more valid way for achieving the objective of “simulating the behaviour of a flat diaphragm using a classic compression driver”, was devised by Christian Heil and described in U.S. Pat. No. 5,163,167.

The system foresees a wave guide that takes the emission of the compression driver by means of a phasing plug that, with the walls of the wave guide itself, creates a narrow annular duct which is circular at the plane of the throat where the emission takes place, then gradually changes it into an duct with the form of a rectangular slot at the end. This emission slot can in turn become the throat plane of a next coupled horn or wave guide, in such a way as to control dispersion on the horizontal plane. The aim of the phasing plug is to get each emission point of the circular throat plane of the driver to reach the new rectangular throat plane at the end of the duct, covering the same distance, in such as way as to reproduce the same planar wave found at the throat of a compression driver in rectangular rather than circular form. The dimensions of the annular duct are very small and therefore avoid creating destructive interference due to internal reflections between the walls of the wave guide and the phasing plug. FIGS. 6A, 6B, 6C and 6D are diagrams showing the innovation of Heil able to perfectly simulate the cylindrical wavefront of a flat diaphragm. In particular, FIG. 6A shows a horizontal cross section of a driver with phasing plug; FIG. 6B shows a vertical cross section of the same driver with a phasing plug; FIG. 6C is an assonometric view showing the driver with phasing plug with the sound output slot coupled with a horn or front wave guide; FIG. 6D is a diagram of two units one above the other with phasing plug fitted in a speaker column for a cylindrical wavefront.

It seems clear that Heil's system is geometrically exemplary and essentially correct for achieving the result, compared to those less correct ones based on coupling various wave guides, hom, etc. An in fact, the performance of this system, which has the peculiarity of emitting a cylindrical wavefront at high frequencies too, has enabled to design line array which operate well over the entire audio band, including high frequencies (FIG. 6D).

Another valid solution to the problem was recently found by using a particular reflecting wave guide for the reproduction of high frequencies, which is the object of Italian patent application BS2001A000073 dated Mar. 10, 2001 and French patent application 001149 del Aug. 9, 2000. The operating principle of the aforesaid reflecting wave guide is schematized respectively in FIGS. 7A, 7B, 7C, 7D, 7E, 8A, 8B and 8C and is based on the reflection of the sound emitted by the throat of a compression driver by means of a flat, parabolic, hyperbolic or elliptical surface, according to the type of dispersion required. The sound emitted by the driver's circular throat, before being reflected passes through a wave guide formed on one side by parallel, convergent or divergent walls and on the other diverging conically or with some other geometric flair, in order to form at a given distance from the initial throat another so-called diffraction throat with a rectangular shape (a slot) which is positioned just before or just after the portion of reflecting surface, creating planar, divergent or convergent sound waves.

In particular:

FIG. 7A shows, from above and as a cross-section, a reflection pattern on a flat surface; FIG. 7B shows a similar reflection pattern on a parabolic surface before the first throat plane; FIG. 7C shows a similar reflection pattern on a parabolic surface after the second throat plane; FIG. 7D also shows a similar reflection pattern on a hyperbolic surface; FIG. 7E shows a reflection pattern on an elliptical surface, whereas

FIG. 8A shows the pattern of a wave guide with a real (above) and theoretical (below) parabolic refection surface; FIG. 8B shows the pattern of a wave guide with a real (above) and theoretical (below) hyperbolic reflection surface; and FIG. 8C shows the pattern of a wave guide with a real (above) and theoretical (below) elliptical reflection surface.

This solution offers doubtless advantages which are also of a geometric nature, because folding the high frequency wave guide (normally straight to avoid creating destructive interference inside it) near the reflection surface, precisely to avoid internal interference, facilitates reduction of the dimensions of the enclosure in which its fitted.

What's more, its acoustic operation, at least in the case of the parabolic reflecting surface, resembles that of the flat diaphragm it tries to emulate. In fact, a parabola works according to the diagram in FIG. 9A1 and is able to concentrate planar sound waves cutting its surface in its focus and/or emit planar waves starting from a point source put in the same focus, maintaining an identical signal path from the source to the emission plane in question FIG. 9A2.

Closely analysing the geometry of the device proposed in the aforesaid patent applications, one realizes that the emulation of flat diaphragm emission isn't completely successful and doesn't achieve the degree of perfection that on the contrary the geometry used by Heil enables his device to achieve regarding emission of planar sound waves.

In fact, the reflecting parabolic surface, described as being able to transform the planar spherical sound wave emitted by the compression driver into a rectangular planar sound wave, which is the prerequisite for forming “vertical line arrays” operating well at high frequencies, needs, for this to take place, for there to be a source which is effectively a point source and doesn't have dimensions such as that of the throat of a driver, no matter how small.

In fact, analysing the parabola, by means of schematic designs, it can be noticed that, due to its shape, it can't reflect in parallel beams the sound emitted by any source other than a point source positioned in its focus and therefore, in this case, cannot come close to the operation of flat diaphragms for planar waves. It also seems clear that the paths from every point of the source to the surface of emission can't remain the same, as is necessary to avoid the occurrence of the typical interference due to different arrival times of the signal reproduced by the device. This also happens in the case of the reflecting wave guide if it's really a parabolic concave surface that reflects, as appears in the aforementioned patent applications. In fact, since the real sound emission is not point source emission, virtual point source emission can't be formed outside the wave guide if a parabolic reflection surface is used—FIG. 9A3.

It should be mentioned, for completeness, that the same obviously also happens for the other reflecting surfaces mentioned in the aforementioned patent applications, flat, concave or convex in the numerous variations, as moreover is shown in FIGS. 9B1, 9B2, 9B3, 9C1, 9C2 and 9C3 which schematically reproduce the effects achieved when there are hyperbolic and elliptical reflecting surfaces.

In short, the conditions for optimum sound reflection, those strictly comparable with theoretical conditions, particularly those ensured by a parabola, the only reflection surface by means of which it's possible to approach the emission conditions of a flat diaphragm (indispensable for good vertical line array operation at high frequencies), only exist effectively and totally if the source is single-point. When the real source has certain dimensions which aren't negligible, and in the professional sound reinforcement sector for reasons of power these dimension can't be reduced below a certain limit, the sound emission obtained with the reflection method get further and further from achieving the emission characteristics of a flat diaphragm, the larger the source's dimension and the higher the frequency band to be reproduced by reflection.

### SUMMARY OF THE INVENTION

This invention intends overcoming this restriction of a physical nature and thus achieve flat diaphragm loudspeakers' dispersion characteristics, even using traditional cone or compression loudspeakers, such as high frequency drivers, in order to make versatile sound emission systems suited for forming vertical lines arrays.

The objective of the invention is achieved by means of the transformation of a source with the typical dimensions of real loudspeakers, firstly into a virtual point source with characteristics identical to a real point source and later, in a second stage, obtaining from this “real” point source the required sound dispersion by means of reflection with various types of surfaces with different shapes, keeping the sound paths exactly the same from any point of the active source to the measurement or listening position via the reflection surface. This reflection surface can be flat, parabolic, hyperbolic or elliptical, or more generally speaking, flat, concave or convex.

### BRIEF DESCRIPTION OF THE DRAWINGS

While all aforementioned diagrams from FIG. 1 to 9 regard the current situation, the following designs are relative to the invention that will be described more in detail, and in them:

FIGS. 10A, 10B, 10C, 10D and 10E schematize the transformation of a real flat source into a “real” point source by means of a parabolic concave reflection surface and also schematize the sound diffusion by means of the same parabolic (convex) surface (FIG. 10A), a flat surface (FIG. 10B), a hyperbolic (concave) surface (FIG. 10C), a parabolic (concave) surface (FIG. 10D) and an elliptical (concave) surface (FIG. 10E);

FIGS. 11A, 11B, 11C and 11D are axonometric diagrams of some examples of acoustic reflectors actually reproducing the aspects of this invention schematized in FIG. 10; among these, FIG. 11C shows the use, in the twin-reflection wave guide, of seven separators of the duct to eliminate internal interference at high frequencies;

FIG. 12 schematizes the transformation of a real planar source into a real point source and the sound paths with the same length obtained with a combination of several reflection surfaces;

FIG. 13A shows an example of an enclosure in one of its practical forms;

FIGS. 14A and 14b show an example of multiple use of the enclosure in FIG. 13A, where the stacked enclosures are up against each other and inclined in relation to each othe; and

FIGS. 15A, 15B and 15C are also views taken from different positions of an enclosure with walls which can be angled differently to modify the dimensions and volume of its front cavity.

### DETAILED DESCRIPTION OF THE INVENTION

As already said and shown in the aforementioned diagrams, the aim of the invention is to transform a primary sounds source with dimensions which aren't negligible and a geometrical surface of various types into a “real” Point source, which enables to obtain the optimum condition of sound reflection for each of the flat, concave or convex reflection surfaces, and in particular the parabolic one which give sound emission of the type obtained with flat isophase diaphragms, the most suited to use in vertical line arrays at high frequencies. The aim is achieved by using a portion of the convex parabola (21), constructed with rigid reflecting material, positioned in front of a sound source (22) with non-point source dimensions (i.e. the throat of a compression driver) and comparable with the dimensions of the real sound sources, such as loudspeakers.

This parabolic convex surface (21), strictly and univocally obtained by applying the mathematic formula which carries out the calculation of the parabola, transforms the emission for flat waves of the real source (21), into the virtual emission typical of a real point source (23) positioned outside the parabolic reflecting surface.

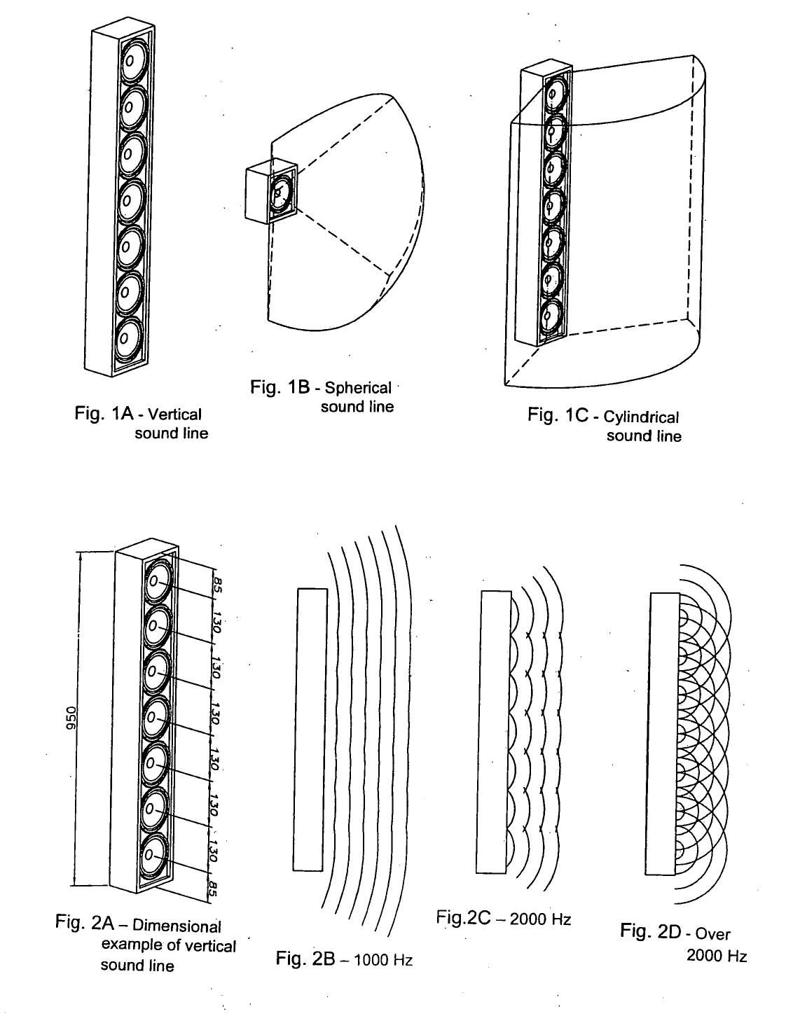

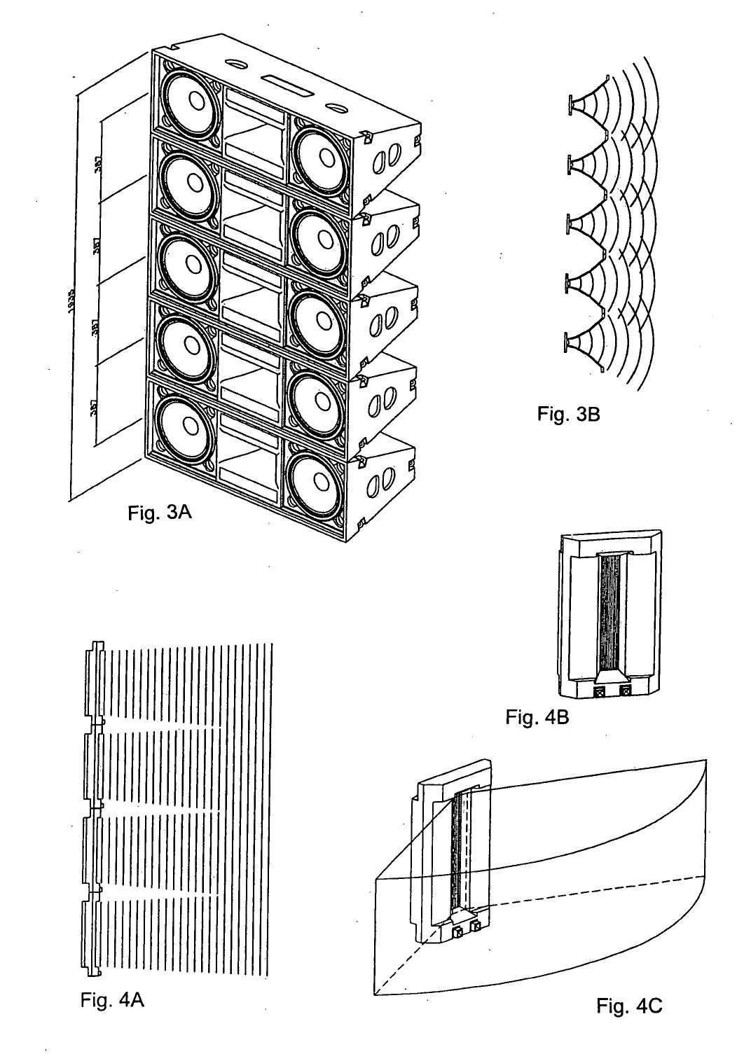

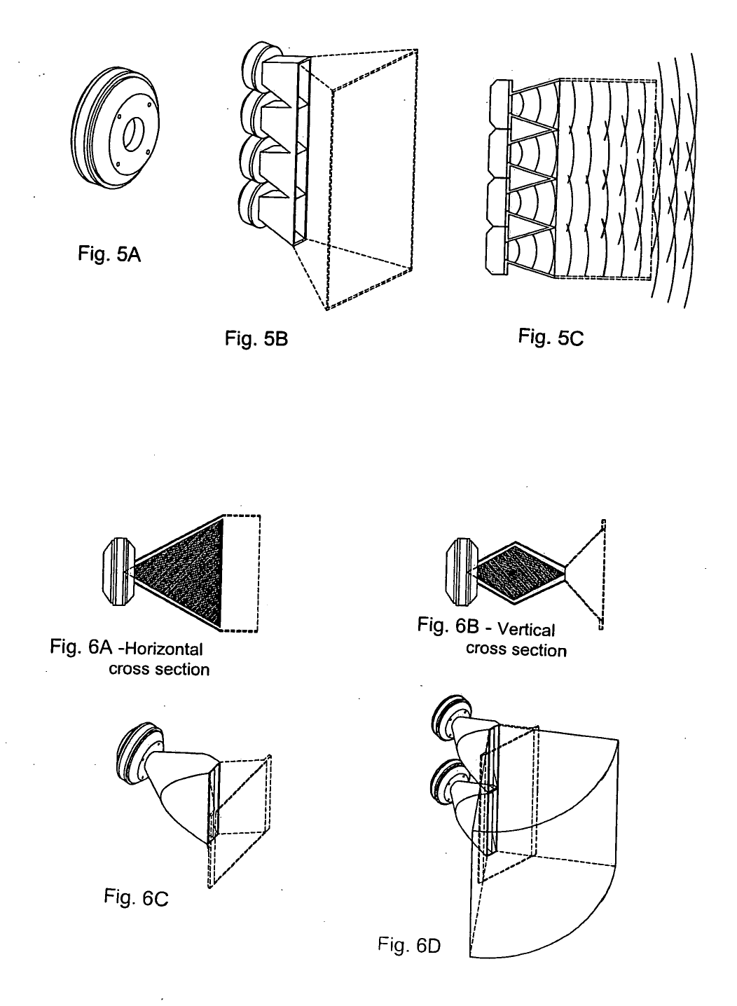

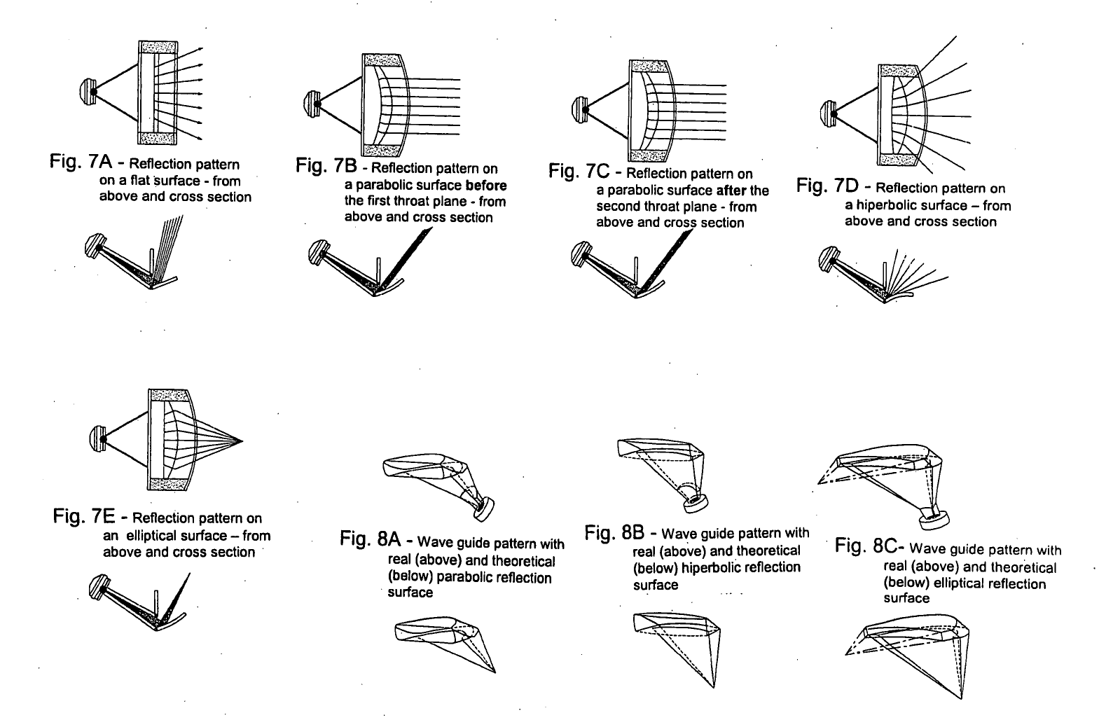

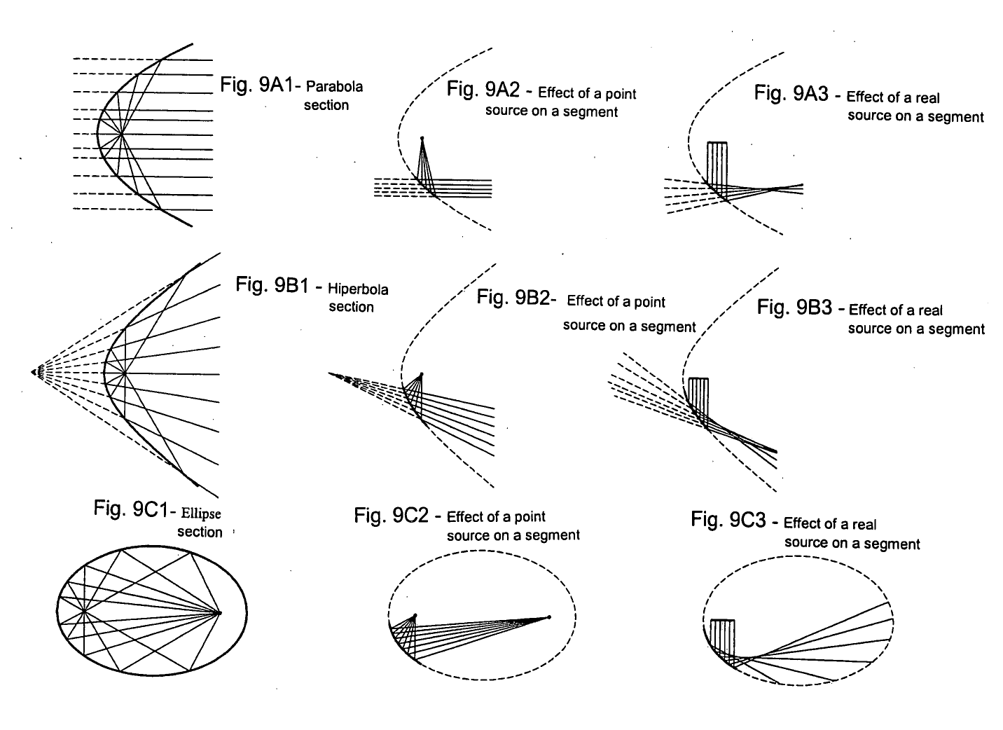

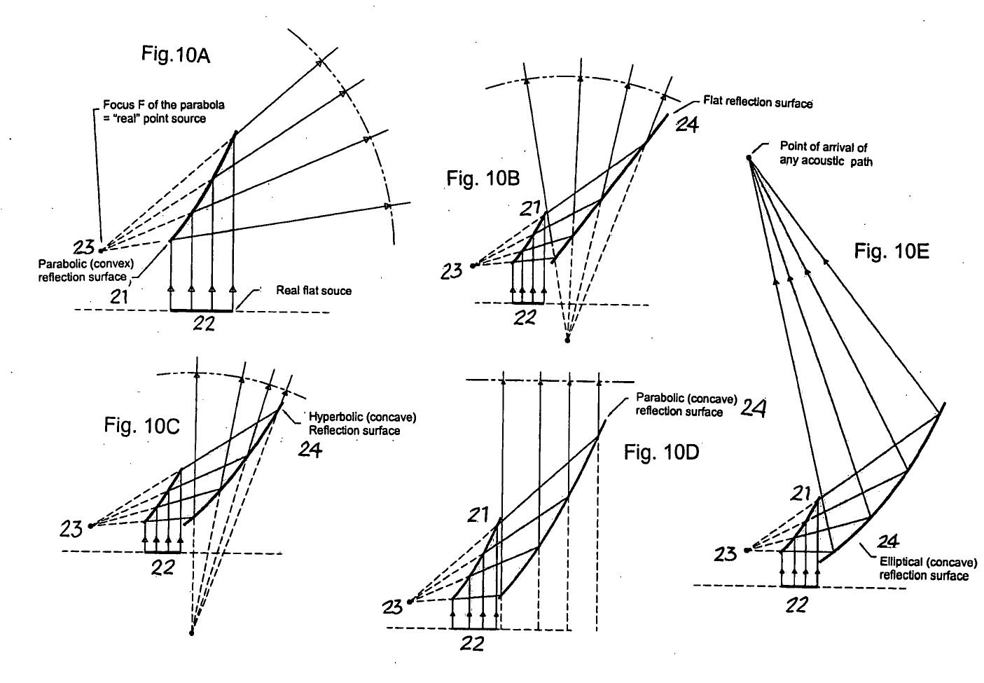

This enables to realize the necessary “real” point source, obtained from any suitable sound source with real dimensions (22). Moreover, as in every circumstance in which reflection is involved, as is the case in optics, it's also possible, with the inverse process of that which has just been described, to transform real divergent, convergent or flat emission, into the same number of real planar emission surfaces as can be clearly seen in FIGS. 10A, 10B, 10C, 10D and 10E.

Thus, and in a very simple manner, by using a second reflecting surface (24), obviously rigid and like the first suited to avoiding even the lowest loss of reflected sound energy and will take the required form according to needs: flat, convex or concave (hyperbolic, parabolic, elliptic etc.), it's possible to obtain coherent sound emission by virtue of equal sound path lengths, with propagation characteristics according to the reflection surface used and in particular, in the case of the parabolic surface, with the typical sought-after flat diaphragm characteristics. These surfaces, apart from the flat one, will be built with the focus in the same point in which the portion of convex parabola has its focus (F) and therefore coinciding with the “real” point source. FIGS. 10A, 10B, 10C, 10D and 10E.

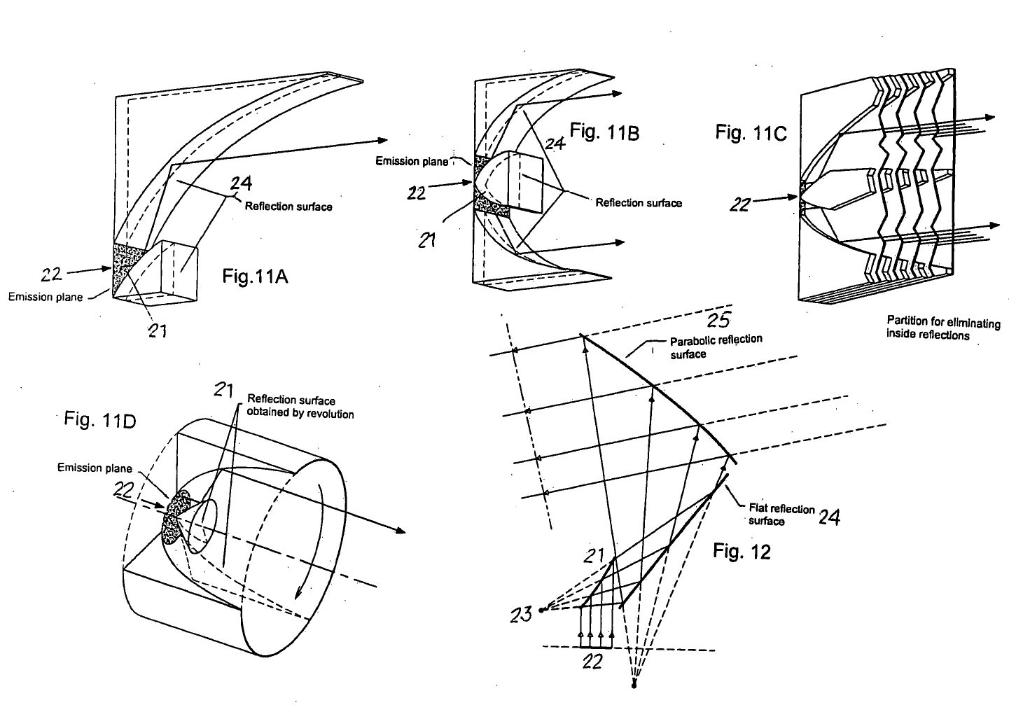

This method isn't limited to the examples illustrated in the diagrams, but can also be used in a large number of variations, some examples of which are shown in axonometric diagrams (FIGS. 11, 11A, 11B, 11C and 11D), in which identical number indicate parts which are the same or equivalent to those in FIG. 10 and where the reflection surfaces can be made by extruding revolving the profile, with dimensions and shapes calculated according to the type of emission required.

FIG. 11C shows a further illustration of FIG. 11B with the addition of the parallel walls which form the sides of the twin-reflection wave guide and the addition of the parallel intermediate walls which work as partitions, with the aim of creating ducts inside the wave guide itself with dimensions which are smaller that the wavelength of the highest frequency which must pass through them, in order that destructive reflections or interference aren't created.

Moreover, results very similar to those described up until now can also be obtained by using several coordinated reflection surfaces (25), as in the additional example, shown schematically and in cross-section to simplify matters in FIG. 12.

In the preceding description, reference was made to one primary sound source of negligible dimensions to be transformed into a “real” sound point source as illustrated also in FIGS. 10-12. However, the primary sound source may also be made up of a group of two or more distinct sound sources. In a first case, the various sound sources are each reflected by an own parabolic reflecting surface to a point coincident for all the sources, which becomes a single “real” point source which will be reflected once more, emitted and directed towards the measurement or listening position by means of one of the parabolic, hyperbolic, elliptic or flat reflecting surfaces mentioned.

In a second case, the various sources are each reflected by an own parabolic reflecting surface to generate the same number of “real” point sources, which will be reflected by another parabolic reflecting surface to a point coincident for all the sources, which becomes a single “real” point source, once more reflected, diffused and directed towards the measurement or listening position by means of the aforementioned parabolic, hyperbolic, elliptic or flat reflecting surfaces.

The objective of these two cases is to take advantage of the energy of multiple distinct sound sources, not necessarily close to each other, concentrating it into a single virtual point source, from which to then reflect the sound by means of a reflecting surface chosen on the basis of the type of diffusion required.

Likewise, it is also possible to divide a single primary sound source into a many sections, each associated with its own parabolic reflecting surface in order to generate the same number of “real” point sources. The point sources achieved in this way are then concentrated, by means of a further parabolic reflecting surface, into a single “real” point source which will then be once again reflected, diffused and directed towards the measurement point or listening position by one of the aforementioned parabolic, hyperbolic, elliptic or flat reflecting surfaces.

As a large dimensioned source, such as for example a cone loudspeaker, cannot validly reproduce high frequency due to the way it is built and because of interference connected with the size of the sound emitting membrane, the method explained above has the objective of dividing, from the point of view of sound diffusion, the membrane into several smaller sections so as to exploit the emission of each section, capturing it and reflecting it so as to achieve a better response for a larger frequency band.

This versatility which, as well as giving the most correct solution to the acoustic and propagation problems connected with the dimensions of the sources with real dimensions, increases the amount of freedom of the designers when working on the shape of the enclosures, is exclusively due to having been able to create a virtual point source which corresponds exactly to a “real” point source.

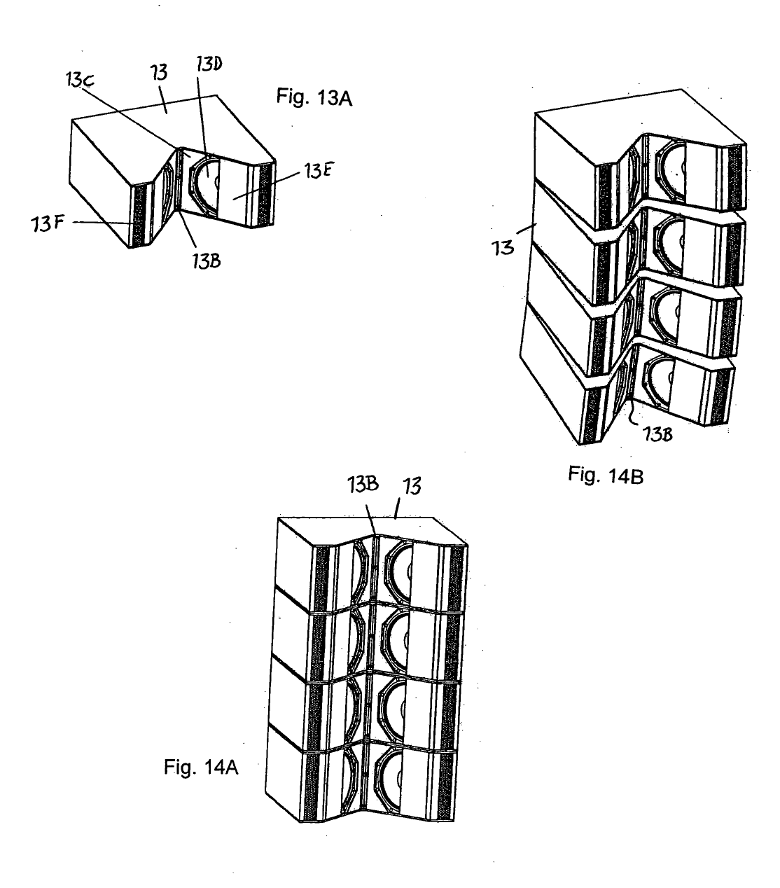

As a non-restrictive example, in order to better illustrate the invention and its use, a summary description is included of an enclosure suited for multiple use in vertical line arrays in which the wave guide described has been fitted and in which all those geometric expedients optimizing performance have been adopted—FIGS. 13A, 14A and 14B.

FIG. 13A shows the enclosure which has (although in no way restrictive) a body (13) a modified parallelepiped shape without a front part, trapezium-shaped footprint and with the same height as the parallelepiped. Since this part is missing, viewed from the front, the body of the enclosure has a cavity defined by sides walls 13C but which is open above and below. At the top of the cavity, in the centre of the parallelepiped body, there's an emission slot for the high frequency wave guide (13B), which is also described in detail in FIGS. 11B and 11C with the seven partitions clearly shown. On the side walls (13C), which are symmetrically positioned with respect to the aforementioned slot and the enclosure's median axis, the mid and low frequency loudspeakers (13D) can be seen, with the half of their diameter towards the front of the enclosure covered by rigid “bulkhead” panel (13E). Alongside the front cavity, there are two slots (13F) covered by a sound-transparent grille, which form the opening for the mid low loudspeakers mounted in the sides of the cavity and/or forming the outward emission surfaces for the sound produced by any other loudspeakers mounted inside the enclosure in (for example) “band pass” configuration with the front volume tuned.

The aim of the bulkhead panel (13E) is on one hand to bring the emission axis of the mid frequencies reproduced by the loudspeakers in the cavity closer to the slot of the reflecting wave guide positioned in the centre, in such a way as to contain it, as is explained by line array theory, within the dimension of ½ the length of the highest frequency they have to reproduce, and on the other to shift the phase of the emission of the loudspeakers' diaphragms, reducing the differences of path of the sound emission from the vibrating surface of the diaphragm itself in relation to whoever is listening in front of the enclosure.

In fact, the sound emitted by the half of the loudspeaker closer to the listener is compelled by the bulkhead (13E) to take a longer path, which effectively becomes, with reference to the frequencies reproduced, the same as that taken by the sound of the other half of the loudspeaker facing directly into the cavity.

The lack of top and bottom panels for the part of the volume corresponding to the front cavity has the aim of preventing any vibration or interference due to reflections against parallel or divergent walls and to allow the formation of a real break-free vertical speaker column for all the frequencies reproduced using multiple enclosures one on top of each other (FIG. 14A), even when, for vertical dispersion requirements, they have to be inclined in relation to each other (FIG. 14B).

The twin-reflection wave guide and the aforementioned construction geometry enable to build the enclosure in complete respect of the theory on Line Arrays briefly quoted in the initial description.

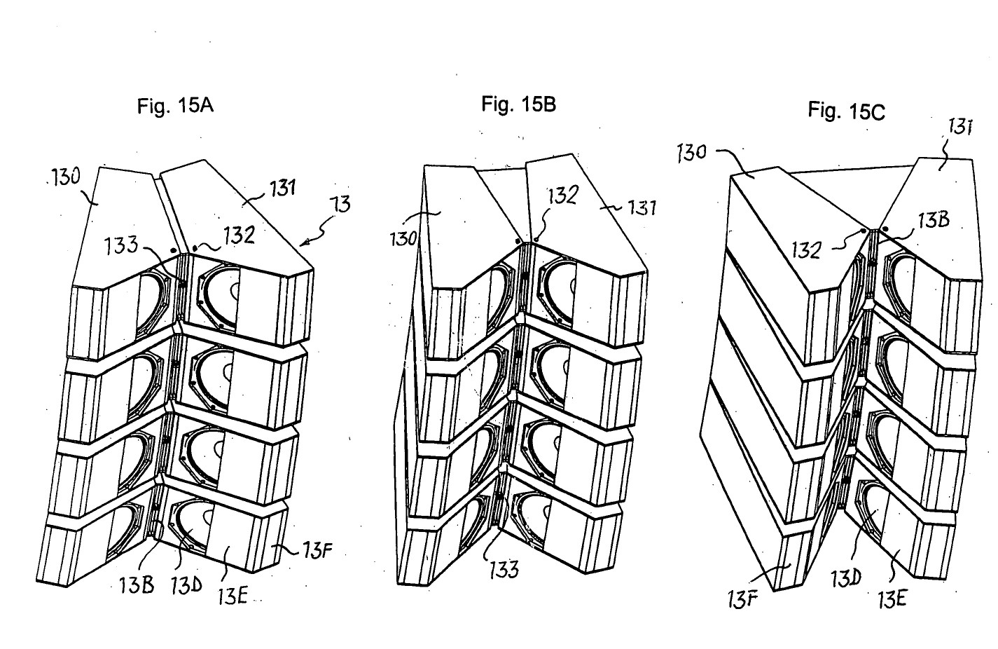

Furthermore and advantageously, the body (13) of the enclosure is made up of two portions (130, 131) rocking on an axis in common or each one on an own oscillating axis (132). The side walls (13C) defining the front cavity each form a part of a portion (130, 131) of the body and the axis or axes of said portions of the body (130, 131) are close to and parallel with the emission slot (13B) at the bottom of said cavity. In this way, as shown in FIGS. 15A, 15B, 15C, the two portions of the body (130, 131) may be inclined differently in respect to each other, at the same time or independently, so as to vary in this way the dimension and consequently the volume of the front cavity and also calibrate the horizontal dispersion of the sound.

To be noted also that in the centre of the slot (13B) at the bottom of the front cavity of the body (13) a laser ray tracking system (133) may be located coinciding with the high frequency emission axis.

1. A method of sound diffusion for realization of a horn or reflecting wave guide for sound emission in a vertical line array, characterized by the steps of:
transformation of a sound emission source with dimensions which are not negligible into a virtual point sound source exactly identical to a “real” point sound source, said sound emission source being a single sound source or a source composed of two or more sound source, and diffusion of the sound of the “real” point source, thus obtained, towards a measurement or listening position, reflecting the sound by means of at least one reflecting surface of various geometric forms, maintaining equal sound paths from any point of the emission source.

2. The method according to claim 1, in which the sound emission source emits a planar wave and its transformation into a “real” point source is achieved by means of a parabolic convex shaped reflecting surface, with the “real” point source being positioned in the focus of the aforementioned parabolic reflecting surface.

3. The method according to claim 1, in which at least one surface reflecting the sound from the point sound source is flat.

4. The method according to 1, in which at least one reflection surface of the sound from the point sound source is convex.

5. The method according to claim 4, in which at least one sound-reflecting surface is parabolic.

6. The method according to claim 1, in which at least one surface reflecting the sound from the point source sound is concave.

7. The method according to claim 6, in which at least one reflection surface is hyperbolic or parabolic.

8. The method according to claim 1, in which at least one reflection surface of the sound from the point source is elliptical.

9. The method according to claim 1, in which the sound from the point source is reflected by means of more than one flat and/or concave and/or convex surface combined.

10. The method according to claim 1, in which the sound emission source is a compression driver.

11. The method according to claim 1, in which the sound emission source is a traditional loudspeaker or has the dimension of a normal loudspeaker.

12. Method according to claim 1 in which the reflecting surfaces define (starting from the surface of the emission source) a volume of air subdivided by seven partitions spaced in such a way as to form ducts with dimensions which are smaller than the wavelength of the highest acoustic frequency that has to pass through them.

13. Reflecting wave guide for sound emission in vertical line arrays starting from a sound emission plane consisting in a flat sound source, characterized by a sound reflection surface positioned in front of the sound emission plane and configured to transform the aforesaid sound emission plane into a real point source, and by at least one reflection surface combined with the aforesaid real point source is intended to diffuse the sound towards a measurement or listening position.

14. Wave guide according to claim 13, in which the aforementioned reflection surface positioned in front of the sound emission plane has a convex parabolic form, in which at least one reflection surface of the sound associated with the real point sound source has a geometry which can be planar, concave or convex surfaces or their combinations.

15. Wave guide according to claim 14, in which each of the planar, concave or convex reflection surfaces has a planar, parabolic, hyperbolic or elliptical form.

16. Wave guide according to claim 13, in which each of the aforementioned reflection surfaces is formed by the surface of elements in rigid reflecting material formed by extrusion of revolution.

17. Wave guide according to claim 13, also having parallel intermediary panels forming seven horizontal partitions forming ducts in the wave guide whose dimensions are smaller than wavelength of the highest frequency that has to pass through them.

18. Wave guide according to claim 13, in which the sound emission plane is a compression driver.

19. Wave guide according to claim 13, in which the sound emission plain is a traditional loudspeaker.

20. Wave guide according to claim 13, wherein:
the means of sound emission are enclosed in a body (13) having a cavity at the front formed on opposite sides by two divergent side walls (13C), and open from two other opposite sides,
on the bottom of said cavity there is an emission slot (13B) for high frequency, and
facing each of said side walls there is at least a part of a loudspeaker (13D) for medium and low frequency, and wherein:
each loudspeaker is partially covered by a rigid panel (13E), and
on the front of the body, at the sides of said cavity there are two slots (13F) forming external apertures of sound ducts of the loudspeakers for medium low tones and/or sound emission of additional loudspeakers housed in the body.

21. Wave guide according to claim 20, wherein said body is made up of two portions (130,131) rocking on an oscillating axis placed near and parallel to the emission slot (13B) at the bottom of said cavity in order to be able to change the dimension, therefore the volume of the front cavity of the body and calibrate the horizontal dispersion of the sound by varying the angular disposition of the side walls forming said cavity.

22. Wave guide according to claim 20, wherein a laser beam tracking system (133) is positioned in the center of the emission slot (13B) at the bottom of said front cavity coinciding with the high frequency emission axis.
